(19) United States
(12) Patent Application Publication
(10) Pub. No.: US 2007/0131181 A1
(43) Pub. Date: Jun. 14, 2007

(54) Motor vehicle coolant circuit comprising a pump and a retarder

(75) Inventor: Klaus Vogelsang, Crailsheim (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Voith Turbo GmbH & Co. KG, Heidenheim (DE)

(21) Appl. No.: 10/565,015

(22) PCT Filed: Jul. 9, 2004
(86) PCT No.: PCT/EP04/07546

§ 371 Date: Jul. 6, 2006

(30) Foreign Application Priority Data
Jul. 19, 2003 (DE) 103 32 907.2

(51) Int. Cl. F01P 7/14; F01P 1/06; F02N 17/06

(52) U.S. Cl. 123/41.1; 123/41.31; 123/142.5 R

(57) ABSTRACT

A coolant circuit of a motor vehicle, including the following features: a coolant, especially water or a water mixture; a coolant pump having a coolant outlet; a retarder provided with a central ring, the working medium thereof being the coolant; a reversing valve in the flow direction upstream of the retarder and a bypass section for bypassing the retarder, such that the retarder can be connected to and disconnected from the coolant circuit. According to the invention, the coolant pump is arranged in the flow direction upstream of the retarder in such a way that it pumps coolant into the retarder when the retarder is connected, and pumps coolant past the retarder via the bypass section when the retarder is disconnected.

### RELATED APPLICATIONS

This application claims priority in PCT International Application No. PCT/EP2004/007546, filed Jul. 9, 2004, and German Application No. DE 103 32 907.2-16 filed Jul. 19, 2003, the contents of which are incorporated herein by reference.

### BACKGROUND OF THE INVENTION

1. Field of the Invention

The invention relates to a coolant circuit of a motor vehicle, which comprises both a coolant pump and a retarder, the working medium of the retarder being the coolant.

2. Description of the Related Art

A hydraulic oil has been conventionally used as the working medium of a retarder in the driveline of a motor vehicle. On account of the heat produced in the braking mode, the hydraulic oil had to be cooled. Provided for this purpose was, as a rule, an oil-water heat exchanger as interface between the cooling circuit and the working medium circuit of the retarder, by means of which the requisite quantity of heat was dissipated from the retarder circuit into the cooling circuit of the vehicle.

In recent times, retarders have also become known that are arranged directly in the conventional coolant circuit of the vehicle and whose working medium is the coolant of the cooling circuit. The provision of such retarders in the cooling circuit can result in an increase in the total flow resistance or the resistance of flow of the coolant in the cooling circuit.

Such an increase in the total flow resistance takes place to a substantial extent also in the case of so-called oil retarders on account of the additional components in the coolant circuit, such as, for example, the oil-water heat exchanger. This increase in the flow resistance has drawbacks. Accordingly, it is not possible to employ any conventionally dimensioned coolant pump, such as those finding use in cooling circuits without retarders. Instead, a higher power coolant pump must be be used.

More power is required to drive the higher power coolant pump and this leads to an increased fuel consumption of the motor vehicle. This is of especially great consequence due to the fact that this increased power input of the coolant pump

### SUMMARY OF THE INVENTION

The invention is based on the problem of creating a coolant circuit that has a coolant pump and a retarder and that is improved over the prior art. In particular, it should be possible to use a coolant pump that does not require a higher power input or power output than coolant pumps in cooling circuits without retarders.

The problem of the invention is solved by the features of claim 1. The subclaims describe especially advantageous constructions.

### BRIEF DESCRIPTION OF THE DRAWINGS

The invention and its advantages over the prior art will be described below on the basis of the figures, FIG. 1 depicting a coolant circuit in accordance with the prior art and FIGS. 2 to 11 showing advantageous constructions or details of advantageous embodiments of coolant circuits of the invention.

Shown in detail are the following:

FIG. 1 a schematic depiction of a motor vehicle coolant circuit having a separately arranged retarder working medium circuit with an oil retarder;

FIG. 2 a first embodiment of a coolant circuit of the invention;

FIG. 3 a second embodiment of a coolant circuit of the invention;

FIG. 4 a third embodiment of a coolant circuit of the invention;

FIGS. 5a, 5b a sectional depiction through a reversing valve;

FIG. 6 a plane-projected depiction of the stator of a retarder;

FIG. 7 an advantageous embodiment of holes in retarder filling blades;

FIG. 8 another embodiment of the hole in a retarder filling blade;

FIG. 9 a third possible embodiment of the holes in a retarder filling blade;

FIG. 10 a fourth possible embodiment of holes in a retarder filling blade;

FIG. 11 a fifth possible embodiment of the holes in a retarder filling blade.

### DETAILED DESCRIPTION OF THE INVENTION

Evident in FIG. 1 are a coolant circuit 10 and a retarder working medium circuit 11. In accordance with the prior art, the two circuits are constructed separately. The coolant in the coolant circuit 10 is circulated by means of the coolant pump 1 and the working medium in the retarder circuit 11 is circulated by means of the retarder 2. The two circuits are connected to each other by means of an oil-water heat exchanger 12 in such a way that the heat generated in the retarder 2 is transferred to the coolant circuit 10. Conventionally, the heat is dissipated from the coolant circuit 10 by means of a water-air radiator 16 together with a fan wheel 13. Insofar as there exists no necessity of dissipating the heat from the coolant circuit 10 on account of the coolant temperature, the coolant is conveyed past the radiator by means of the bypass 14. A thermostat 15 is provided for an appropriate regulation.

The flow of cooling medium, particularly the flow of cooling water that is required for transporting energy is moved by the pump 1, via the engine 5, the water-carrying part of the oil-water heat exchanger 12, via the thermostat 15, and via the water-air radiator 16 to the intake side of the pump 1. The flow resistances that are present in the circuit need to be overcome by the pump 1 during this circulation; that is, the power input or power output of the pump must be sufficiently high that the pressure of the working medium at the pump outlet 1.1 due to the pressure level produced by the pump lies so far above the pressure level on the intake side that an appropriate circulating flow is established throughout the entire coolant circuit.

Additional resistances in the coolant circuit reduce and impede the circulating flow of cooling water and thus the quantity of heat that can be effectively transferred or else, for the same flow of cooling water, necessitate a more powerful pump, which entails an increased power input. Such an increased power input leads to an increase in fuel consumption, which is not desired.

Such an additional resistance is created, for example, by the oil-water heat exchanger 12. When one considers that the retarder is required for braking during only about 10 percent of the time the vehicle is being employed, the remaining 90 percent of the time the vehicle is being employed means a pump operation with unnecessarily high power input.

FIG. 2 shows a coolant circuit constructed in accordance with the invention. In it, the corresponding elements are identified by the same reference numbers as in FIG. 1.

As can be seen, the retarder 2 is arranged directly in the coolant circuit and can be bypassed by way of the bypass section 4. Arranged in the flow direction upstream of the retarder 2 is a reversing valve 3 for controlling the flow—either through the retarder 2 or through the bypass 4.

The coolant pump 1, arranged upstream of the reversing valve 3, corresponds, in terms of its power range, to a coolant pump of a coolant circuit without a directly incorporated retarder or without an incorporated oil-water heat exchanger for a separate retarder circuit, such as is depicted in FIG. 1. In the non-braking mode (in relation to the retarder), the coolant pump 1 circulates the coolant in the coolant circuit 10, namely, starting with the pressure level of the coolant outlet 1.1 of the pump 1, via the reversing valve 3, the bypass 4, the engine 5, the thermostat 15, the radiator 16 (or, possibly, at least in part via the bypass 14 that bypasses it), to the intake side of the pump 1. Thus, even though a retarder can be connected in the coolant circuit, no additional flow resistance need be overcome. To this end, the reversing valve 3 is designed in an especially advantageous manner in such a way that it creates no additional impedance of the flow circuit. An especially advantageous construction of such a reversing valve is depicted in FIG. 5 and is described further below.

In the braking mode of the retarder, the flow resistance between the pump outlet 1.1 and a position in the central ring of the retarder 2 is laid out in such a way that it lies below the previously described total flow resistance of the coolant circuit in the non-braking mode. Accordingly, the power of the pump 1 is adequate to make available an adequate superimposed pressure for the retarder 2, so that the latter takes over the remaining pumping work for circulating the coolant in the coolant circuit 10 up to the intake side of the pump 1. One aspect of the embodiment depicted may thus be seen in the fact that the pump 1 overcomes only the resistance path from the coolant outlet 1.1 of the pump up to the retarder 2, that is, more precisely stated, up to the central ring of the retarder 2. The flow resistance in the remaining coolant circuit is overcome by the connected retarder. This is readily possible if one considers that the coolant pump has a power range that is in a ratio of 1:100 in comparison to the power range of the retarder in terms of possible pumping capacity. For example, the pump has a power of approximately 6 kilowatts and the retarder has a power range of 500 to 600 kilowatts.

Due to the fact that, in accordance with the invention, the flow resistance that is to be overcome by the coolant pump 1 in the braking mode is lower than in the non-braking mode, an increased circulated quantity of cooling medium is established. This is especially of advantage in the braking mode of the retarder in order to increase the thermal availability of such a braking system and thus to expand in a comparable manner the possible wear-free braking mode, which, in turn, leads to a relief of the friction brakes provided in the vehicle. Due to the fact that the retarder is arranged in the flow direction upstream of the engine 5 that is being cooled, it is possible to keep especially low the flow resistance that is to be overcome by the coolant pump, on the one hand, which, in turn, increases the throughput at the same speed, and, on the other hand, the working medium in the retarder has a relatively low temperature.

Shown in FIG. 3 is an alternative embodiment of a coolant circuit 10. This time, the engine 5 is arranged downstream of the coolant pump 1 and upstream of the reversing valve 3 when it is viewed in the flow direction. In spite of this, in accordance with the invention, the flow resistance between the cooling medium outlet 1.1 of the pump 1 and the central ring of the retarder 2 is chosen in such a way that it is lower than the total flow resistance in the coolant circuit when the retarder 2 is disconnected, that is, when flow occurs through the bypass 4.

The advantage of this embodiment is that the coolant heated in the retarder is cooled directly afterwards in the radiator 16. When the retarder is constructed appropriately, it is possible to permit coolant temperatures that lie above the permitted coolant inlet temperatures at the engine 5.

In the embodiment shown according to FIG. 2, it is possible to achieve an especially short coolant-carrying path between the coolant pump 1 and the retarder 2 in the case when the retarder is constructed in the system as a primary retarder in terms of its mechanical incorporation. Primary retarder means that the retarder is arranged in a drive connection on the drive side of the transmission between the engine 5 and a transmission, which is not depicted. Due to the fact that the water pump and the retarder are thus both arranged on the engine side with respect to the transmission, it is possible to construct the short means of carrying the flow between the pump 1 and the retarder 2 and to realize a correspondingly lower flow resistance.

The arrangement according to FIG. 3 offers, in addition to the advantages mentioned, the additional advantage that the retarder 2 can be constructed especially easily as a secondary retarder. Secondary retarder means that the retarder is arranged in a drive connection on the drive side of the transmission, that is, between the transmission and the wheels of the vehicle. This is advantageous, because, on the drive side of the transmission in the frame region of a vehicle, more construction space is available than in the region of the engine compartment on the drive side of the transmission.

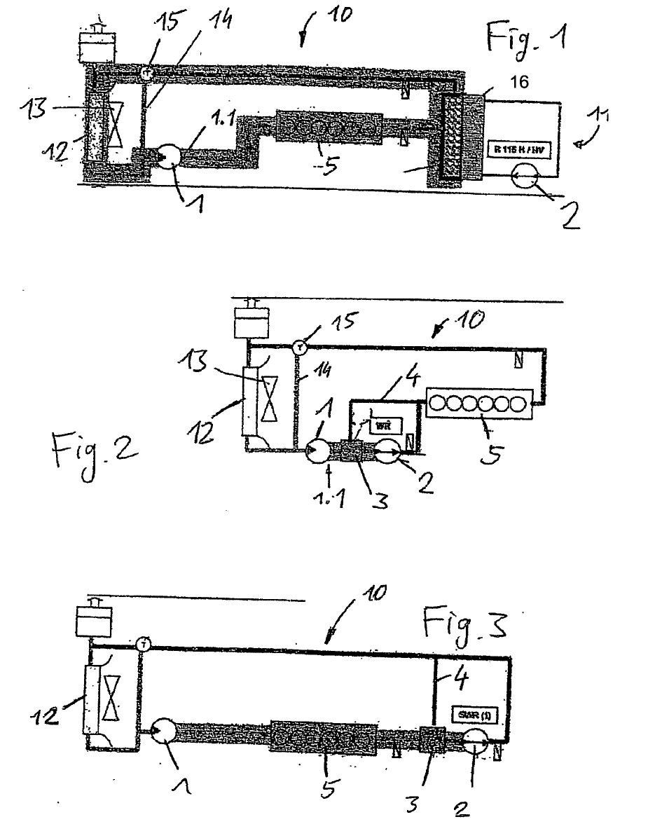

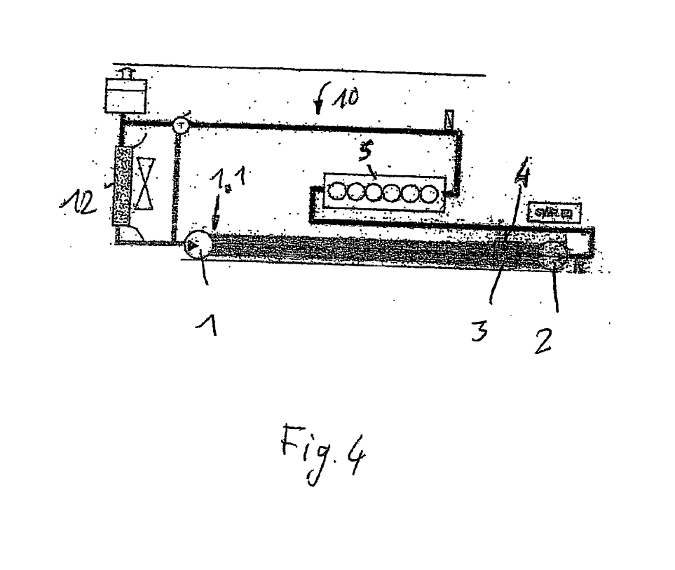

Depicted in FIG. 4 is an embodiment in which the retarder 2 is arranged in a secondary manner in terms of its mode of mechanical action, that is, on the drive side of the transmission, whereas, in terms of its arrangement in the coolant circuit, it is arranged upstream of the engine 5.

In this embodiment also the carrying of the flow from the outlet 1.1 of the coolant pump 1 up to the central ring of the retarder 2 is designed in such a way that the flow resistance of this path is lower than the flow resistance in the non-braking mode of the entire coolant circuit 10.

In all of the embodiments shown, it may be especially advantageous to make an adaptation of the flow resistance between the pump outlet 1.1 and the central ring of the retarder 2 by way of a predetermined number of holes in the filling system of the retarder. The number and/or the size of the holes or of the respective filling cross sections are chosen advantageously according to the respective resistance characteristics of the vehicle cooling system used.

In the following, several constructions for adjusting an especially low flow resistance are presented.

FIGS. 5a and 5b show schematically an advantageous embodiment of a reversing valve 3. The reversing valve 3 shown is constructed as a rotary slide valve and has an inlet 3.1, a first outlet 3.2, and a second outlet 3.3. Cooling medium is introduced via the inlet 3.1 at least indirectly by the coolant pump 1. Via an outlet—for example, the outlet 3.2—coolant is diverted into the bypass 4 around the retarder and, via another outlet—for example, the outlet 3.3—to the retarder 2.

Furthermore, the reversing valve 3 has a cylindrical valve piston 3.4, which can rotate around its longitudinal axis. The cylindrical valve piston has radial holes, namely, an outlet hole 3.5 and an inlet hole 3.6. The outlet hole 3.5 typically has a cylindrical construction, whereas the inlet hole 3.6 has a conically tapering construction or a funnel-shaped construction. One, both, or several holes can obviously also have other shapes in terms of their cross section—for example, the shape of an oblong hole. Rotation of the cylindrical valve piston 3.4 around its longitudinal axis connects the inlet 3.1 with one of the two outlets 3.2 and 3.3 in a targeted manner.

For the above-described connections of the outlets 3.2 and 3.3, the state of the non-braking mode of the retarder is shown in FIG. 5a and the state of the braking mode is shown in FIG. 5b.

The conically tapering inlet hole 3.6 has an inlet opening on the circumference of the valve piston 3.4 that is dimensioned in such a way that, regardless of the position of the valve piston 3.4—that is, regardless of whether the latter connects the inlet 3.1 to the outlet 3.2 in a flow-carrying manner or whether it connects the inlet 3.1 to the outlet 3.3—the inlet opening of the inlet hole 3.6 completely surrounds the flow cross section of the inlet 3.1.

The design of the rotary slide valve, which is shown, results in a solution that is extremely favorable in terms of flow and offers low resistance.

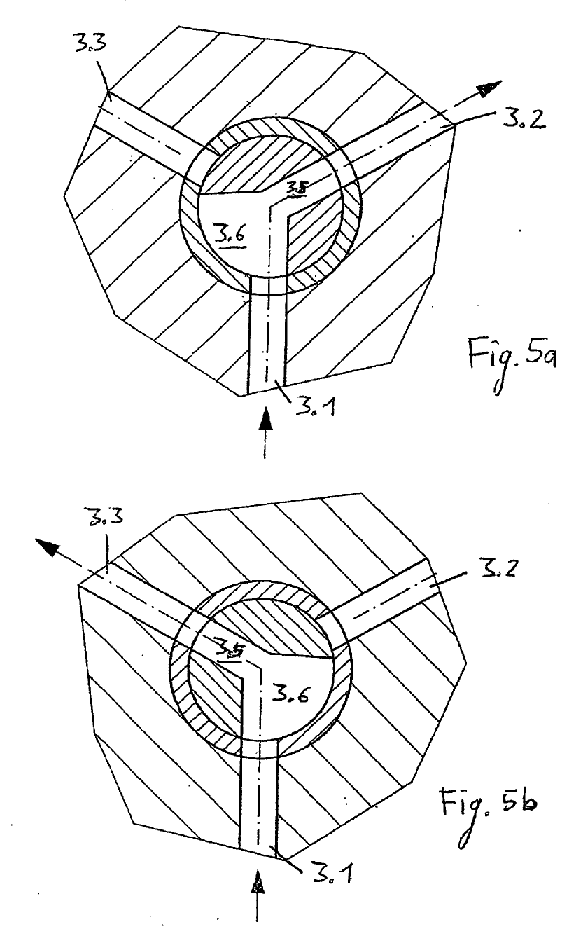

FIG. 6 shows a retarder inlet region that is advantageously designed in terms of a low-resistance flow into the region of the central ring of the retarder. Shown here is a partial region of the stator 2.2 of the retarder 2 in a plane-projected depiction.

The stator 2.2 has a plurality of stator blades 2.7. A predetermined number of the stator blades 2.7 are provided with a hole 2.3 for introducing the working medium into the working chamber of the retarder 2.4. In the embodiment shown, every second stator blade 2.7 has such a hole 2.3. In an extreme case, each stator blade would have a corresponding hole. Stator blades with holes are also referred to as filling blades.

The inlet into the central ring region of the retarder corresponds to the stator outlet, that is, to the discharge of the working medium out of the holes 2.3 into the filling blades.

The working medium flows on the inlet side of the working medium, 2.5, via a central hole 2.8, over the entire circumference of the stator 2.2. In order to achieve an especially uniform distribution of the incoming flow over the entire circumference, a number of guide elements 2.6, particularly in the form of ribs, are provided on the stator inlet side.

The uniform distribution of the working medium, which enters through the central hole 2.8, over the entire stator circumference and thus the uniform distribution onto all filling blades, particularly onto every stator blade or every second stator blade, results in an especially low-resistance flow up to the central ring of the retarder, that is, up to the stator outlet.

FIG. 7 shows a further measure for a flow-favorable design of the retarder inlet region. In it, two parallel holes 2.3 for introducing working medium into the working chamber of the retarder are made in each filling blade of the stator, that is, particularly into every blade or every second blade of the stator. Further evident is the inlet channel 2.9 in the stator housing 2.10, which is constructed as a ring-shaped channel (see the indicated dot-dash center line). Inside of the inlet channel 2.9, the stator is provided with guide elements 2.6 on its inlet side.

However, it is not necessary to construct the ring channel in a rotationally symmetric manner with respect to the center line. Deviating shapes—on account of, for example, the construction space available on the transmission—can also be constructed.

Provided in the stator housing 2.10 radially outside of the inlet channel 2.9, which is constructed as a ring-shaped channel, is an outlet channel 2.11, which is also constructed as a ring-shaped channel, in order to carry off working medium from the retarder working chamber via a retarder outlet.

FIGS. 8 to 11 show further measures in the region of the filling blades that decrease the flow resistance. Thus, according to FIG. 8, the holes 2.3 in the filling blades of the stator are constructed as conically tapering channels, the inlet opening of which extends, in the region of the guide element 2.6, over nearly the entire height of the inlet channel 2.9 and, in the region of the stator outlet side, takes the shape of an oblong hole or a square.

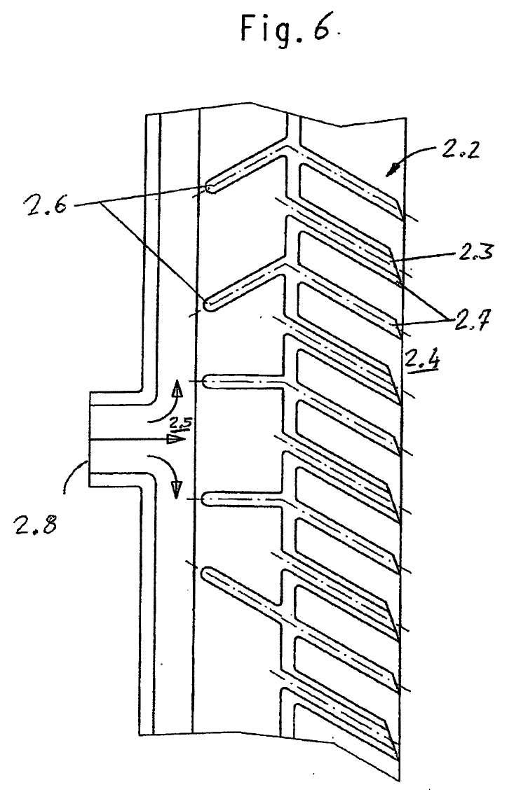

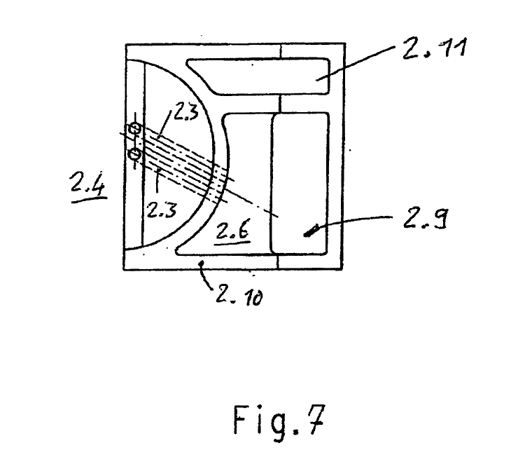

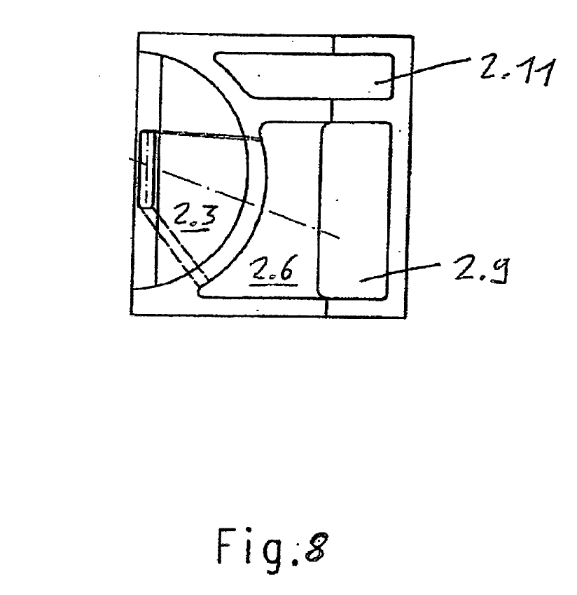

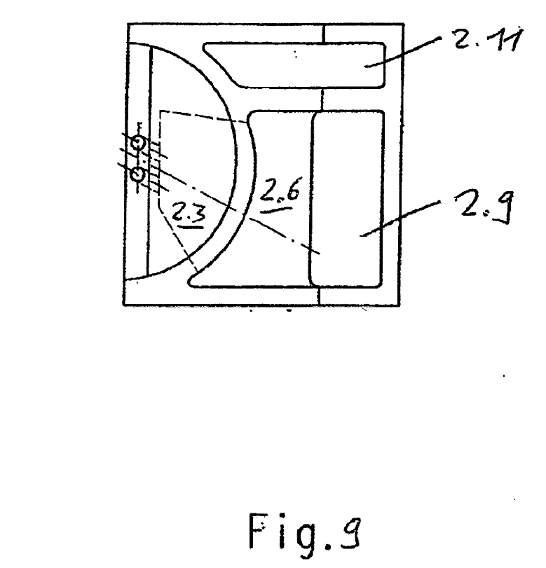

FIG. 9 shows a combination of a conically tapering inlet channel that has two holes, the inlet channel merging into the two holes.

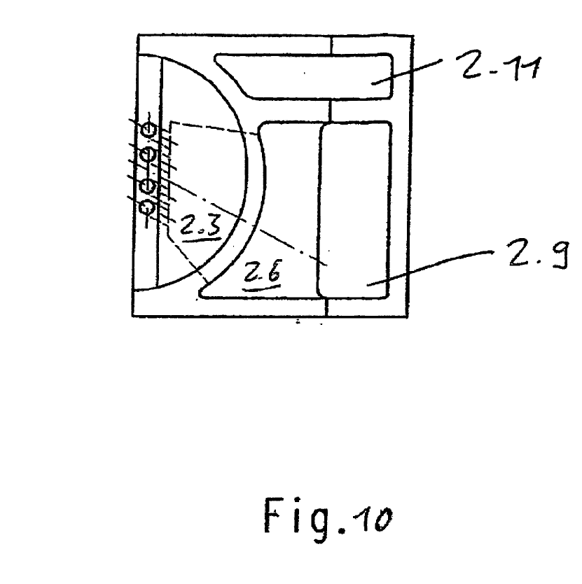

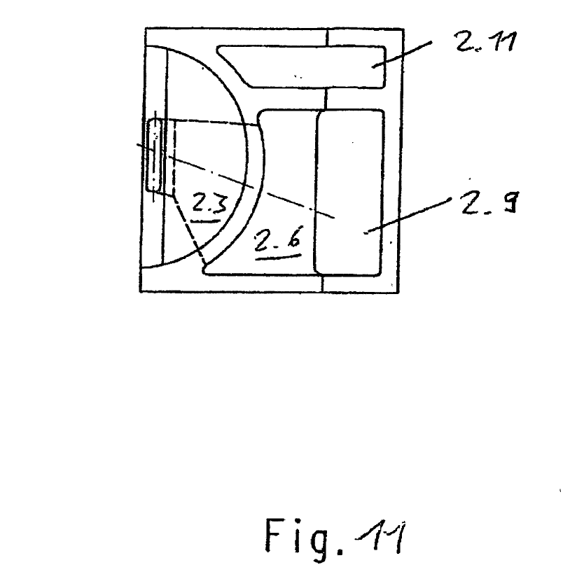

FIG. 10 shows an inlet channel that merges into four stator blade holes.

Finally, FIG. 11 shows an initially conically tapering channel in the stator blade, which then merges, as viewed in the flow direction, into a channel having a constant cross section.

1-10. (canceled)

11. A coolant circuit of a motor vehicle having a coolant flowing therethrough and the motor vehicle having an engine, the coolant circuit comprising:
a coolant pump having a coolant outlet;
a retarder having a central ring and being selectively connectable to the coolant circuit;
a reversing valve upstream of the retarder;
a bypass section for bypassing the retarder,
wherein the retarder can be connected to and disconnected from the coolant circuit,
wherein the coolant pump is upstream of the retarder and provides coolant past the retarder via the bypass section when the retarder is disconnected from the coolant circuit, and
wherein the coolant outlet of the coolant pump to the central ring of the retarder has a first flow resistance that is measured when the retarder is connected to the coolant circuit and is lower than a second flow resistance to be overcome by the coolant pump when the retarder is disconnected from the coolant circuit.

12. The coolant circuit of claim 11, wherein the coolant comprises water or a water mixture.

13. The coolant circuit of claim 11, wherein the first flow resistance is between approximately 5% to approximately 30% lower than the second total flow resistance.

14. The coolant circuit of claim 11, wherein the retarder is connected in series with the coolant circuit, the coolant pump, and the reversing valve.

15. The coolant circuit of claim 11, wherein the retarder is downstream of the engine and the coolant pump is upstream of the engine.

16. The coolant circuit of claim 11, wherein the retarder is upstream of the engine and the coolant pump is downstream of the engine.

17. The coolant circuit of claim 11, wherein the retarder is a secondary retarder.

18. The coolant circuit of claim 11, wherein the reversing valve is constructed as a rotary slide valve comprising:
an inlet and two outlets;
a cylindrical valve piston rotatable about a longitudinal axis, the cylindrical valve piston comprising
an outlet hole being incorporated into the valve piston in a radial direction and which can be aligned in a flush manner with each of the outlets by rotating the valve piston;
an inlet hole being incorporated in the valve piston in the radial direction and connected to the outlet hole in a flow carrying manner;
wherein the inlet hole has a construction that is conically tapering proceeding radially from the outside to the inside; and
wherein the radial outer opening surface has a diameter that is enlarged in such a way that there is a constant flow-carrying connection to the inlet, regardless of the alignment of the outlet hole with an outlet.

19. The coolant circuit of claim 11, wherein the retarder further comprises:
a working chamber;
a stator with a plurality of holes on an inlet side for introducing at least a portion of the coolant into the working chamber; and
a plurality of guide elements, uniformly distributed over a circumference of the stator on the inlet side to provide for the uniform distribution of the at least a portion of the coolant over the stator circumference.

20. The coolant circuit of claim 19, wherein the plurality of guide elements comprise ribs.

21. The coolant circuit of claim 19, wherein the plurality of holes are conically enlarged in the flow direction.

22. The coolant circuit of claim 19, wherein the stator further comprises a plurality of stator blades.

23. The coolant circuit of claim 22, wherein the plurality of holes are located in a predetermined number of the plurality of stator blades.

24. The coolant circuit of claim 23 wherein the plurality of holes are a plurality of parallel holes.

25. The coolant circuit of claim 23 wherein at least one hole is located on each stator blade.

26. The coolant circuit of claim 23 wherein at least one hole is located on every other stator blade.

27. An engine comprising:
a coolant circuit of a motor vehicle having a coolant flowing therethrough and the motor vehicle having an engine, the coolant circuit comprising:
a coolant pump having a coolant outlet;
a retarder having a central ring and being selectively connectable to the coolant circuit;
a reversing valve upstream of the retarder;
a bypass section for bypassing the retarder,
wherein the retarder can be connected to and disconnected from the coolant circuit,
wherein the coolant pump is upstream of the retarder and provides coolant past the retarder via the bypass section when the retarder is disconnected from the coolant circuit, and
wherein the coolant outlet of the coolant pump to the central ring of the retarder has a first flow resistance that is measured when the retarder is connected to the coolant circuit and is lower than a second flow resistance to be overcome by the coolant pump when the retarder is disconnected from the coolant circuit.

28. The engine of claim 27 further comprising a transmission wherein the retarder is connected to a drive side of the transmission.
